(19) United States
(12) Patent Application Publication
(10) Pub. No.: US 2010/0113657 A1
(43) Pub. Date: May 6, 2010

(54) FLAME-RETARDANT POLYAMIDE COMPOSITION

(75) Inventor: Masashi Seki, Chiba (JP)

Correspondence Address: BUCHANAN, INGERSOLL & ROONEY PC, POST OFFICE BOX 1404, ALEXANDRIA, VA, 22313-1404, US

(73) Assignee: Mitsui Chemicals, Inc, Minato-ku (JP)

(21) Appl. No.: 12/594,142

(22) PCT Filed: Mar. 28, 2008
(86) PCT No.: PCT/JP2008/000805

§ 371 Date: Sep. 30, 2009

(30) Foreign Application Priority Data
Mar. 30, 2007 (JP) 2007-090371

(51) Int. Cl. C08K 5/5313

(52) U.S. Cl. 524/133

(57) ABSTRACT

Disclosed is a flame-retardant polyamide composition which is excellent in mechanical properties such as toughness, and heat resistance, flame retardancy and flow ability during a reflow soldering process. In addition, this polyamide composition exhibits high thermal stability during molding. Specifically disclosed is a flame-retardant polyamide composition containing (A) 20-80% by weight of a specific polyamide resin, (B) 10-20% by weight of a metal phosphinate, (C) 0.05-1% by weight of a lithium salt, a calcium salt, a barium salt, a zinc salt or an aluminum salt of montanic acid, behenic acid or stearic acid. It is preferable that this flame-retardant polyamide composition contains no halogen flame retardant.

### TECHNICAL FIELD

The present invention relates to a flame-retardant polyamide composition.

### BACKGROUND ART

As materials for electric parts, polyamide resins have been used that can be molded into desired shape by heat melting. In general, aliphatic polyamides such as Nylon 6 and Nylon 66 are used in many fields. These aliphatic polyamides generally have excellent moldability, but are insufficient in heat resistance as resin materials for surface-mounted components such as connectors that are exposed to high temperatures in a reflow soldering process.

Against the backdrop of this situation, Nylon 46 was developed as a polyamide that exhibits high heat resistance; however, Nylon 46 has the disadvantage of high water absorbency. For this reason, electric parts molded of a Nylon 46 resin composition undergo size change due to water absorption under certain circumstances. When a molded article of the Nylon 46 resin composition absorbed water and is then heated in a reflow soldering process, unwanted “blisters” occurs. To avoid environmental problems, particularly in recent years, surface-mounting technologies using lead-free solders have been increasingly employed. As lead-free solders have higher melting points than conventional lead-based solders, the mounting temperature have inevitably increased by 10-20° C. than before, making the use of Nylon 46 more and more difficult.

To overcome this problem aromatic polyamides were developed, which are the polycondensates of aromatic dicarboxylic acids (e.g., terephthalic acid) and aliphatic alkylene diamines. Aromatic polyamides have the feature of higher heat resistance and lower water absorbency than aliphatic polyamides such as Nylon 46. Aromatic polyamides may have higher rigidity than Nylon 46, but have the disadvantage of insufficient toughness. In particular, if the material of a thin and fine-pitch connector is insufficient in toughness, it may result in cracking and/or clouding in the product when the terminals are pressed into or plucked from a device. Therefore, there is an increasing need for materials with much higher toughness.

Toughness can be enhanced by increasing the polyamide resin proportion and reducing the flame retardant amount. However, electric parts like connectors are often required to have high flame retardancy and flame resistance sufficient to meet the Underwriters Laboratories (UL) 94 V-0 requirements. Therefore, materials are needed that can have high toughness without losing flame retardancy.

As available flame retardants, halogen-containing flame retardants such as brominated polyphenylene ether, brominated polystyrene and polybrominated styrene are typically used. However, halogen compounds generate toxic hydrogen halide gas when they are burned. With increasing concern on global warming, development of halogen-free flame retardants with high heat resistance has been considered imperative. For development of such flame retardants, attention is directed to the use of phosphinates (see Patent Documents 1-5).

Patent Document 1: Japanese Patent Application Laid-Open No. 2006-522842

Patent Document 2: International Application Publication No. WO2005/033192

Patent Document 3: International Application Publication No. WO2005/035664

Patent Document 4: International Application Publication No. WO2005/121234

Patent Document 5: Japanese Patent Application Laid-Open No. 2007-023206

### DISCLOSURE OF INVENTION

### Problems to be Solved by the Invention

Although flame retardancy is ensured in the above conventional agents, they lack solder heat resistance, mechanical properties (e.g., toughness), flow ability necessary for molding into small electric parts, etc., and thus do not necessary meet all of the required properties.

The present invention provides a halogen-free, flame-retardant polyamide composition which generates no halogen compound when burned; has excellent thermal stability during molding under high temperature conditions; has high flame retardancy, flow ability and toughness; and has good heat resistance in a reflow soldering process for surface mounting using lead-free solder.

### Means for Solving the Problem

In light of the foregoing situation, the inventor conducted extensive studies and completed the present invention by establishing that a flame-retardant polyamide composition, which contains a specific polyamide resin, a phosphinate as a flame retardant, and a specific fatty acid metal salt, is a material that is excellent in molding stability, flame retardancy, flow ability and toughness and that has good heat resistance in a reflow soldering process for surface mounting using lead-free solder.

That is, a first aspect of the present invention relates to a flame-retardant polyamide composition and molded article thereof below.

[1] A flame-retardant polyamide composition including:

20-80 wt % polyamide resin (A);

10-20 wt % flame retardant (B) containing no halogens in the molecule thereof;

0.05-1 wt % fatty acid metal salt (C); and

0-50 wt % reinforcement (D),

wherein the flame retardant (B) is a phosphinate, and the fatty acid metal salt (C) is a lithium salt, calcium salt, barium salt, zinc salt or aluminum salt of montanic acid, behenic acid or stearic acid (except for calcium stearate and aluminum stearate), or a mixture thereof.

[2] The flame-retardant polyamide composition according to [1], wherein the polyamide resin (A) comprises multifunctional carboxylic acid unit (a-1) and multifunctional amine unit (a-2) having 4-25 carbon atoms, and 60-100 mol % of the multifunctional carboxylic acid unit (a-1) is a terephthalic acid unit, 0-40 mol % of the multifunctional carboxylic acid unit (a-1) is a multifunctional aromatic carboxylic acid unit other than terephthalic acid, and 0-40 mol % of the multifunctional carboxylic acid unit (a-1) is a multifunctional aliphatic carboxylic acid unit having 4-20 carbon atoms.
[3]. The flame-retardant polyamide composition according to [1] or [2], wherein the polyamide resin (A) has a melting point of 280-340° C. and an intrinsic viscosity [η], as measured in concentrated sulfuric acid at 25° C., of 0.5-0.95 dl/g.

A second aspect of the present invention relates to a method of producing a flame-retardant polyamide composition below.

[4] A method of producing a flame-retardant polyamide composition according to anyone of [1] to [3] including:

mixing polyamide resin (A) polymer with phosphinate (B) and fatty acid metal salt (C) to prepare a mixture; and

molding the mixture by melt extrusion molding.

[5] A method of producing a flame-retardant polyamide composition according to any one of [1] to [3] including:

preparing a resin composition containing polyamide resin (A), flame retardant (B), and optionally reinforcement (D);

adding fatty acid metal salt (C) to the resin composition; and

molding the resin composition containing the fatty acid metal salt (C) by extrusion molding.

### ADVANTAGEOUS EFFECT OF THE INVENTION

The flame-retardant polyamide composition of the present invention is free of halogens and is excellent in mechanical properties (e.g., toughness), heat resistance during a reflow soldering process and, in particular, flow ability. Furthermore, the polyamide composition has high thermal stability during molding. For these reasons, the molded article produced from the flame-retardant polyamide composition generates no hydrogen halide when burned, and is excellent not only in thermal stability, flame retardancy, flow ability and toughness during molding, but in heat resistance required for surface mounting using lead-free solder.

Thus, the flame-retardant polyamide composition of the present invention is suitable for the manufacture of electric parts such as thin and fine-pitch connectors, as well as parts which are for surface-mounting using high-melting point solder such as lead-free solder. In addition, with the flame-retardant polyamide composition of the present invention, environment load is reduced.

### BRIEF DESCRIPTION OF DRAWINGS

FIG. 1 shows a graph of reflow process temperature vs. reflow process time in heat resistance tests conducted in Examples and Comparative Examples.

### BEST MODE FOR CARRYING OUT THE INVENTION

### 1. Flame-Retardant Polyamide Composition

As described above, a flame-retardant polyamide composition of the present invention contains polyamide resin (A), flame retardant (B) having no halogens in its molecule, and fatty acid metal salt (C).

Polyamide Resin (A)

Polyamide resin (A) contained in the composition of the present invention has multifunctional carboxylic acid unit (a-1) and multifunctional amine unit (a-2).

Multifunctional Carboxylic Acid Unit (a-1)

Preferably, 60-100 mol % of the multifunctional carboxylic acid unit (a-1) is a terephtalic acid unit, 0-40 mol % of the multifunctional carboxylic acid unit (a-1) is a multifunctional aromatic carboxylic acid unit other than terephtalic acid, and 0-40 mol % of the multifunctional carboxylic acid unit (a-1) is a multifunctional aliphatic carboxylic acid unit having 4-20 carbon atoms.

The amount of the terephthalic acid unit is 60-100 mol %, preferably 60-70 mol %, based on the amount of the multifunctional carboxylic acid unit (a-1). The amount of the multifunctional aromatic carboxylic acid unit other than terephthalic acid is 0-40 mol %, preferably 0-30 mol %, more preferably 0-10 mol %, based on the amount of the multifunctional carboxylic acid unit (a-1).

Examples of the multifunctional aromatic carboxylic acid unit other than terephthalic acid include isophthalic acid, 2-methyl terephthalic acid, naphthalene dicarboxylic acid, phthalic anhydride, trimellitic acid, pyromellitic acid, trimellitic anhydride, and pyromellitic anhydride, with isophthalic acid being particularly preferable. These carboxylic acids may be used alone or in combination. When the multifunctional aromatic carboxylic acid unit contains a multifunctional carboxylic acid unit having three or more functional groups, the contained amount needs to be adjusted so as to avoid gelation of polyamide resin. More specifically, it is preferably contained in an amount of not greater than 10 mol % based on the total amount of the carboxylic acid units.

As the proportion of the multifunctional aromatic carboxylic acid unit increases, polyamide resin's water absorbency decreases and thereby heat resistance tends to increase. Particularly in a case of a reflow soldering process using lead-free solder, the terephthalic acid unit amount is preferably set to 60 mol % or more based on the total amount of the multifunctional carboxylic acid units.

As the amount of the multifunctional aromatic carboxylic acid unit other than terephthalic acid decreases, polyamide resin becomes more crystalline. For this reason, the resultant resin molded article tends to have improved mechanical properties, particularly toughness.

The amount of the multifunctional aliphatic carboxylic acid unit having 4-20 carbon atoms is 0-40 mol %, preferably 30-40 mol %, based on the amount of the multifunctional carboxylic acid unit (a-1).

The multifunctional aliphatic carboxylic acid unit is derived from a multifunctional aliphatic carboxylic acid compound having 4-20 carbon atoms, preferably 6-12 carbon atoms, more preferably 6-10 carbon atoms. Examples of the multifunctional aliphatic carboxylic acid compound include adipic acid, suberic acid, azelaic acid, sebacic acid, decanedicarboxylic acid, undecanedicarboxylic acid, and dodecanedicarboxylic acid. Among them, adipic acid is particularly preferable in view of improving mechanical properties.

Where necessary, the multifunctional aliphatic carboxylic acid unit may further contain a multifunctional carboxylic acid having three or more functional groups; however, the contained amount should be adjusted so as to avoid gelation of polyamide resin. More specifically, it needs to be contained in an amount of not greater than 10 mol % based on the total amount of the carboxylic acid units.

Multifunctional Amine Unit (a-2)

The multifunctional amine unit (a-2) constituting polyamide resin (A) has a linear multifunctional amine unit having 4-25 carbon atoms, preferably 4-8 carbon atoms, which may have a side chain. Moreover, the multifunctional amine unit (a-2) has a linear multifunctional amine unit having 4-8 carbon atoms.

Specific examples of the linear multifunctional amine unit include 1,4-diaminobutane, 1,6-diaminohexane, 1,7-diaminoheptane, 1,8-diaminooctane, 1,9-diaminononane, 1,10-diaminodecane, 1,11-diaminoundecane, and 1,12-diaminododecane. Among them, 1,6-diaminohexane is preferable.

Specific examples of the linear aliphatic diamine unit having a side chain include 2-methyl-1,5-diaminopentane, 2-methyl-1,6-diaminohexane, 2-methyl-1,7-diaminoheptane, 2-methyl-1,8-diaminooctane, 2-methyl-1,9-diaminononane, 2-methyl-1,10-diaminodecane, and 2-methyl-1,1′-diaminoundecane. Among them, 2-methyl-1,5-diaminopentane and 2-methyl-1,8-diaminooctane are preferable.

The multifunctional amine unit (a-2) may have a multifunctional alicyclic amine unit. Examples of the multifunctional alicyclic amine unit include units derived from alicyclic diamines such as 1,3-diaminocyclohexane, 1,4-diaminocyclohexane, 1,3-bis(aminomethyl)cyclohexane, 1,4-bis(aminomethyl)cyclohexane, isophoronediamine, piperazine, 2,5-dimethylpiperazine, bis(4-aminocyclohexyl)methane, bis(4-aminocyclohexyl)propane, 4,4′-diamino-3,3′-dimethyldicyclohexylpropane, 4,4′-diamino-3,3′-dimethyldicyclohexylmethane, 4,4′-diamino-3,3′-dimethyl-5,5′-dimethyldicyclohexyl methane, 4,4′-diamino-3,3′-dimethyl-5,5′-dimethyldicyclohexyl propane, α,α′-bis(4-aminocyclohexyl)-p-diisopropylbenzene, α,α′-bis(4-aminocyclohexyl)-m-diisopropylbenzene, α,α′-bis(4-aminocyclohexyl)-1,4-cyclohexane, and α,α′-bis(4-aminocyclohexyl)-1,3-cyclohexane. Among them, the alicyclic diamine unit is preferably a unit derived from 1,3-diaminocyclohexane, 1,4-diaminocyclohexane, bis(aminomethyl)cyclohexane, bis(4-aminocyclohexyl)methane, or 4,4′-diamino-3,3′-dimethyldicyclohexylmethane, most preferably a unit derived from an alicyclic diamine such as 1,3-diaminocyclohexane, 1,4-diaminocyclohexane, bis(4-aminocyclohexyl)methane, 1,3-bis(aminohexyl)methane, 1,3-bis(aminomethyl)cyclohexane, etc.

When the multifunctional amine unit (a-2) has a multifunctional amine unit having three or more functional groups, the contained amount should be adjusted so as to avoid gelation of resin. More specifically, it is preferably contained in an amount of not greater than 10 mol % based on the total amount of the amine units.

The intrinsic viscosity [η] of polyamide resin (A) of the present invention, as measured in 96.5% sulfuric acid at 25° C., is generally 0.5-1.2 dl/g, preferably 0.65-0.95 dl/g, more preferably 0.75-0.90 dl/g. When the intrinsic viscosity falls within these ranges, a polyamide composition can be obtained that is excellent in flow ability, heat resistance and toughness.

Preferably, polyamide resin (A) is crystalline, i.e., has a melting point. The melting point of polyamide resin (A) is preferably 280-340° C., more preferably 300-340° C., further preferably 315-330° C. The melting point is defined as a temperature corresponding to an endothermic peak in a differential scanning calorimetry (DSC) curve, which is obtained by heating polyamide resin (A) at a heating rate of 10° C./min using a differential scanning calorimeter.

The polyamide resins having the melting points as mentioned above exhibit particularly excellent heat resistance. Moreover, when the melting point is 280° C. or more, 300° C. or more, particularly within 315-330° C., sufficient heat resistance can be imparted to a molded article produced from the polyamide composition even in a lead-free reflow soldering process, particularly in a reflow soldering process using lead-free solder with a high melting point. When the melting point of the polyamide resin is below the decomposition temperature of polyamide (350° C.), e.g., when the melting point is set to 340° C. or below, molding can be carried out without causing such problems as generation of blisters or decomposition gas and color changes of the molded article, thereby obtaining sufficient thermal stability.

Flame Retardant (B)

Flame retardant (B) contained in the flame-retardant polyamide composition of the present invention is a component added to reduce resin flammability. In addition, flame retardant (B) contains no halogens in its molecule.

As flame retardant (B), phosphinates, preferably metal phosphinates are employed in order for the flame-retardant polyamide composition of the present invention to have thermal stability, flame retardancy and flow ability during a molding process at 280° C. or above, heat resistance sufficient to endure reflow temperature of lead-free solder, and toughness comparable to or greater than that of Nylon 46.

Representative examples of phosphinates are compounds having the following formula (I) and/or formula (II).

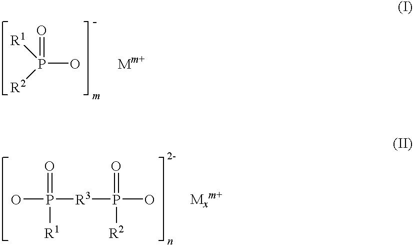

In the formulas (I) and (II) R¹ and R² may be the same or different and each denote linear or branched C₁-C₆ alkyl group, aryl group or phenyl group; R³ denotes linear or branched C₁-C₁₀ alkylene group, C₆-C₁₀ arylene group, C₆-C₁₀ alkylarylene group or C₆-C₁₀ arylalkylene group; M denotes calcium atom, magnesium atom, aluminum atom and/or zinc atom; m is 2 or 3; n is 1 or 3; and x is 1 or 2.

Additional examples of phosphinates include calcium dimethylphosphinate, magnesium dimethylphosphinate, aluminumdimethylphosphinate, zinc dimethylphosphinate, calcium ethylmethylphosphinate, magnesium ethylmethylphosphinate, aluminum ethylmethylphosphinate, zinc ethylmethylphosphinate, calcium diethylphosphinate, magnesium diethylphosphinate, aluminum diethylphosphinate, zinc diethylphosphinate, calcium methyl-n-propylphosphinate, magnesium methyl-n-propylphosphinate, aluminum methyl-n-propylphosphinate, zinc methyl-n-propylphosphinate, calcium methanedi(methylphosphinate), magnesium methanedi(methylphosphinate), aluminum methanedi(methylphosphinate), zinc methanedi(methylphosphinate), calcium benzene-1,4-(dimethylphosphinate), magnesium benzene-1,4-(dimethylphosphinate), aluminum benzene-1,4-(dimethylphosphinate), zinc benzene-1,4-(dimethylphosphinate), calcium methylphenylphosphinate, magnesium methylphenylphosphinate, aluminum methylphenylphosphinate, zinc methylphenylphosphinate, calcium diphenylphosphinate, magnesium diphenylphosphinate, aluminum diphenylphosphinate, and zinc diphenylphosphinate. Among them, calcium dimethylphosphinate, aluminumdimethylphosphinate, zinc dimethylphosphinate, calcium ethylmethylphosphinate, aluminum ethylmethylphosphinate, zinc ethylmethylphosphinate, calcium diethylphosphinate, aluminum diethylphosphinate, and zinc diethylphosphinate are preferable, with aluminum diethylphosphinate being further preferable.

Phosphinates, which serve as flame retardant (B), are readily commercially available. Examples of commercially available phosphinates include EXOLIT OP1230, OP1311, OP1312, OP930 and OP935, which are manufactured by Clariant (Japan) K.K.

Fatty Acid Metal Salt (C)

Fatty acid metal salt (C) contained in the flame-retardant polyamide composition of the present invention is a component added to improve resin flow ability during injection molding. Addition of fatty acid metal salt (C) is effective particularly in the case of a molding process where high resin flow ability is required, such as formation of small and thin electric parts. In particular, when the composition contains polyamide resin (A) whose melting point is 300° C. or above, the processing temperature should be correspondingly increased to 300° C. or above. Thus, in this case, it is effective to employ a specific fatty acid metal salt in order to better balance between resin flow ability and generated gas level during molding.

For fatty acid metal salt (C), any known compound may be used. Examples of fatty acids for fatty acid metal salt (C) include montanic acid, behenic acid, and stearic acid. Examples of metal salts for fatty acid metal salt (C) include lithium salt, calcium salt, barium salt, zinc salt, and aluminum salt. Note however that calcium stearate and aluminum stearate are excluded from fatty acid metal salt (C). Preferred examples of fatty acid metal salt (C) for ensuring both resin flow ability and prevention of gas generation during molding include lithium, calcium, barium, zinc and aluminum salts of montanic or behenic acid, with lithium, calcium and zinc salts of montanic or behenic acid being more preferable. Fatty acid metal salt (C) may contain one or more of the fatty acid metal salts.

Reinforcement (D)

The flame-retardant polyamide composition of the present invention may contain reinforcement (D). As reinforcement (D) various inorganic fillers in the form of fiber, powder, grain, plate, needle, cloth, mat, etc., can be used.

More specifically, reinforcement (D) may be a powdery or plate-shaped inorganic compound such as silica, silica-alumina, alumina, calcium carbonate, titanium dioxide, talc, Wollastonite, diatomite, clay, kaoline, spherical glass, mica, gypsum, red iron oxide, magnesium oxide or zinc oxide; needle-shaped inorganic compound such as potassium titanate; inorganic fiber such as glass fiber, potassium titanate fiber, metal-coated glass fiber, ceramic fiber, Wollastonite, carbon fiber, metal carbide fiber, metal curing product fiber, asbestos fiber or boron fiber; or organic filler such as aramid fiber or carbon fiber.

As a fibrous filler, glass fiber is particularly preferable. With glass fiber, moldability is enhanced, and besides, mechanical properties (e.g., tensile strength, flexural strength and flexural modulus) and heat resistance properties (e.g., heat distortion temperature) of a molded article produced from the polyamide composition are improved. The average length of the glass fiber as reinforcement (D) is usually 0.1-20 mm, preferably 0.3-6 mm, and the aspect ratio (L (average fiber length)/D (average fiber outer diameter)) is usually 10 to 5,000, preferably 2,000 to 3,000.

Reinforcement (D) may be a mixture of two or more different fillers. These fillers may be surface-treated with silane coupling agents or titan coupling agents, e.g., silane compounds such as vinyltriethoxysilane, 2-aminopropyltriethoxysilane or 2-glycidoxypropyltriethoxysilane.

The fibrous filler in the reinforcement (D) may be coated with a binder. As such binders, acrylic compounds, acrylic/maleic derivative modified compounds, epoxy compounds, urethane compounds, urethane/maleic derivative modified compounds and urethane/amine modified compounds are preferably used. The surface-treating agent and binder may be used in combination. The combined use enhances compatibility of the fibrous filler with other components in the composition of the present invention, whereby appearance improves, so too does strength characteristics.

Flame Retardant Synergist

The flame-retardant polyamide composition of the present invention may contain a flame retardant synergist as needed. It is only necessary for the flame retardant synergist to be a component that can significantly increase flame retardancy when combined with a flame retardant. Any known flame retardant synergist can be employed. Specific examples thereof include antimony compounds such as antimony trioxide, antimony tetroxide, antimony pentoxide and sodium antimonate, zinc borates such as 2ZnO.3B₂O₃, 4ZnO.B₂O₃.H₂O and 2ZnO.3B₂O₃.3.5H₂O, zinc stannate, zinc phosphate, calcium borate, calcium molybdate, zinc oxide, calcium oxide, barium oxide, aluminum oxide, tin oxide, magnesium oxide, aluminum phosphate, and boehmite. Additional examples of the flame retardant synergist include salts formed of one or phosphorous compounds selected from phosphoric acid, pyrophoric acid and polyphosphoric acid, and of one or more compounds selected from melamine, melam and melem. These flame retardant synergists may be used alone or in combination.

### Other Additives

The flame-retardant polyamide composition of the present invention may contain, in addition to the above components, various known additives, such as heat stabilizers, weathering stabilizers, flow ability improvers, plasticizers, thickeners, antistatic agents, mold release agents, pigments, dyes, inorganic or organic fillers, nucleating agents, fibrous reinforcing agents and/or inorganic compounds (e.g., carbon black, talc, clay, mica) in amounts that do not affect the object of the present invention.

For example, the flame-retardant polyamide composition of the present invention may contain additives such as general-purpose ion scavengers. A known ion scavenger is, for example, hydrotalcite. In particular, addition of the fibrous reinforcing agent enhances heat resistance, flame retardancy, rigidity, tensile strength, flexural strength and impact strength of the flame-retardant polyamide composition of the present invention.

The flame-retardant polyamide composition of the present invention may further contain other polymers in amounts that do not affect the object of the present invention; examples of such polymers include polyolefins such as polyethylene, polypropylene, poly-4-methyl-1-pentene, ethylene/1-butene copolymer, propylene/ethylene copolymer, propylene/1-butene copolymer and polyolefin elastomer, polystyrene, polyamide, polycarbonate, polyacetal, polysulfone, polyphenylene oxide, fluororesin, silicone resin, PPS, LCP and Teflon®. In addition, the flame-retardant polyamide composition may contain modified polyolefins. Examples thereof include modified polyolefin elastomers which are modified with carboxyl group, acid anhydride group, amino group or the like (e.g., modified polyethylene, modified aromatic vinyl compound/conjugated diene copolymers (e.g., modified SEBS) or hydrogenated products thereof, and modified ethylene/propylene copolymer).

Flame-Retardant Polyamide Composition

The flame-retardant polyamide composition of the present invention preferably contains 20-80 wt %, more preferably 40-60 wt % polyamide resin (A) based on the total amount (100 parts by weight) of polyamide resin (A), flame retardant (B), fatty acid metal salt (C) and reinforcement (D). When the polyamide resin (A) content is 20 wt % or more, sufficient toughness can be obtained. When the polyamide resin (A) content is 80 wt % or less, the flame retardant can be contained in sufficient amount in the composition, so that flame retardancy can be obtained.

The amount of flame retardant (B) is preferably 10-20 wt %, preferably 13-19 wt %, based on the total amount of polyamide resin (A), flame retardant (B), fatty acid metal salt (C) and reinforcement (D). The amount of flame retardant (B) in terms of phosphorous content is 2-5 wt %, preferably 3-4.6 wt %. When the flame retardant (B) content is 10 wt % or more, sufficient flame retardancy can be obtained. When the flame retardant (B) content is 20 wt % or less, it avoids reduction in resin flow ability during molding, toughness etc., of the molded article, and heat resistance temperature.

The amount of fatty acid metal salt (C) is 0.05-1 wt %, preferably 0.1-0.8 wt %, based on the total amount of polyamide resin (A), flame retardant (B), fatty acid metal salt (C) and reinforcement (D). When the fatty acid metal salt (C) content falls within these ranges, flow ability and prevention of gas generation during molding can be ensured. When the fatty acid metal salt (C) content is 0.05 wt % or more, good flow ability may be imparted to the polyamide resin composition. When the fatty acid metal salt (C) content is 1 wt % or less, generated gas level increasing during injection molding can be favorably avoided.

The amount of reinforcement (D) is 0-50 wt %, preferably 20-45 wt %, based on the total amount of polyamide resin (A), flame retardant (B) and fatty acid metal salt (C). When the reinforcement (D) content is 50 wt % or less, flow ability reduction during injection molding can be favorably avoided.

The amount of flame retardant synergist is 0.5-10 wt %, preferably 0.5-5 wt %, more preferably 1-4 wt %, based on the total amount of polyamide resin (A), flame retardant (B), fatty acid metal salt (C) and reinforcement (D).

The flame-retardant polyamide composition of the present invention may further contain the above-described optional other additive(s) in amounts that do not affect the object of the present invention.

The flame-retardant polyamide composition of the present invention preferably meets the UL 94 standard of V-0. In addition, the heat resistance temperature of the flame-retardant polyamide composition, as measured after subjected to moisture adsorption for 96 hours at 40° C. and at relative humidity of 95%, is 250-280° C., more preferably 260-280° C.

The breaking energy of the flame-retardant polyamide composition of the present invention, which is the mechanical property indicative of toughness, is 50-70 mJ, preferably 52-70 mJ. The flow length of the flame-retardant polyamide composition, upon injection molding of the resin into a bar-flow mold, is 50-90 mm, preferably 55-80 mm.

As described above, the flame-retardant polyamide composition of the present invention has excellent heat resistance sufficient to meet the requirement of surface mounting using lead-free solder, as well as toughness comparable to or greater than that of Nylon 46. In addition, the flame-retardant polyamide composition has high melt flow ability, high flame retardancy and high molding stability and is particularly suitable for manufacture of electric parts.

### 2. Preparation Method of Flame-Retardant Polyamide Composition

The flame-retardant polyamide composition of the present invention can be produced with a known resin kneading method. For example, it is possible to employ a method in which raw materials are mixed using Henschel mixer, V-blender, Ribbon blender or tumble blender; or a method in which the mixture is further melt-kneaded using a single-screw extruder, multi-screw extruder, kneader or banbury mixer and then the kneaded product is granulated or pulverized.

In addition, although not specifically limited, the production method of the flame-retardant polyamide composition can be classified into two types according to the method by which fatty acid metal salt (C) is added: (1) Methods in which a composition containing polyamide resin (A), flame retardant (B) and fatty acid metal salt (C), and optionally reinforcement (D), is melt-kneaded to produce a polyamide resin composition; and (2) methods in which fatty acid metal salt (C) is mixed with a pellet formed of the above polyamide resin composition (fatty acid metal salt (C) may or may not be contained in the composition).

Using any of the above methods, a composition can be obtained that shows excellent balance between flow ability during molding and toughness of the molded article. Particuarly, by using the above method (2), a composition that exhibits excellent flow ability during molding can be obtained even when using the same components. Fatty acid metal salt (C) generally has lower heat resistance than polyamide resin (A). Thus, a portion of fatty acid metal salt (C) tends to be vaporized away during extrusion molding. The added amount of fatty acid metal salt (C) may be increased in order to compensate this expected vaporization; however, excessive addition of fatty acid metal salt (C) tends to cause such problems as stickiness and reduced heat resistance. Specifically, when the same amount of fatty acid metal salt (C) is to be added, the method (2) can retain fatty acid metal salt (C) in the composition more readily than any of the other methods.

### 3. Molded Article and Electric Part Material

The flame-retardant polyamide composition can be molded into any desired molded article with a known molding method such as compaction molding, injection molding or extrusion molding.

The flame-retardant polyamide composition of the present invention is excellent in molding stability, heat resistance and mechanical properties and thus can be used in applications where these characteristics are required, or in the field of precise molding. Specific examples include electric parts such as automobile electrical components, circuit breakers, connectors and LED reflection materials, and molded articles such as coil bobbins and housings.

### EXAMPLES

Hereinafter, the present invention will be detailed with reference to Examples, which however shall not be construed as limiting the scope of the present invention. In Examples and Comparative Examples measurement and evaluation of physical properties were conducted as described below.

[Intrinsic Viscosity [η]]

Intrinsic viscosity was measured in accordance with JIS K6810-1977. Sample solution was prepared by dissolving 0.5 g of polyamide resin in 50 ml of 96.5% sulfuric acid solution. The flow-down time of the sample solution was measured using a Ubbelohde viscometer at 25±0.05° C. Intrinsic viscosity [η] was then calculated using the following equation.

[η]=ηSP/[C(1+0.205ηSP)]

ηSP=(t-t0)/t0

[η]: intrinsic viscosity (dl/g)

ηSP: specific viscosity

C: sample concentration (g/dl)

t: sample flow-down time (sec)

t0: flow-down time (sec) of sulfuric acid (blank)

[Melting Point (Tm)]

The melting point of the polyamide resin was measured using DSC-7 (PerkinElmer, Inc.). The polyamide resin was held at 330° C. for 5 minutes, cooled to 23° at a rate of 10° C./min, and then heated at a heating rate of 10° C./min. The endothermic peak based on the melting of the polyamide resin was employed as the melting point.

### [Flammability Test]

A vertical combustion test was performed to evaluate flame retardancy in accordance with the UL94 standard (UL Test No. UL94, Jun. 18, 1991) using a test piece (thickness: 1/32 inch, width: ½ inch, length: 5 inch) prepared by injection molding.

Molding machine: TUPARL TR40S3A (Sodick Plustech Co., Ltd.)

Cylinder temperature: polyamide resin melting point plus 10° C.

Mold temperature: 120° C.

[Heat Resistance Test]

A test piece (length: 64 mm, width: 6 mm, thickness: 0.8 mm) prepared by injection molding was allowed to stand in a humid atmosphere for 96 hours at 40° C. and at relative humidity of 95%.

Molding machine: TUPARL TR40S3A (Sodick Plustech Co., Ltd.)

Cylinder temperature: polyamide resin melting point plus 10° C.

Mold temperature: 100° C.

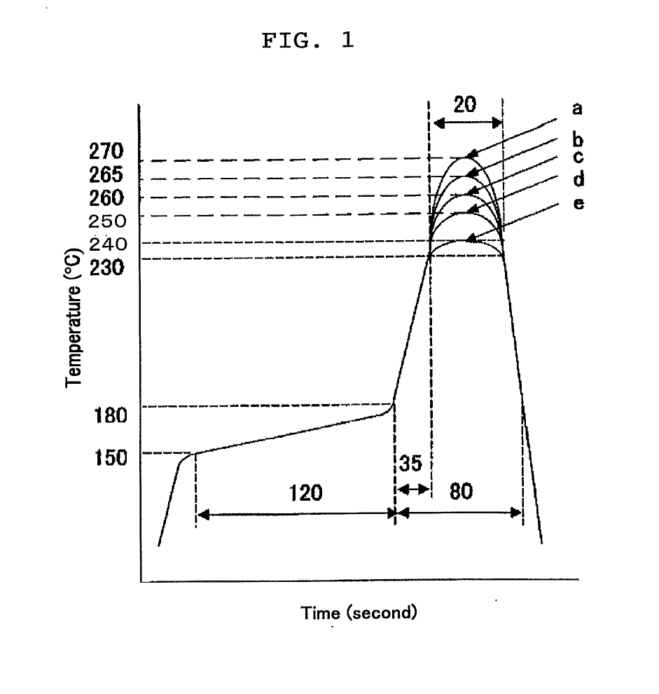

The test piece conditioned above was then placed on a 1 mm-thick glass epoxy substrate. A temperature sensor was placed on the substrate. A reflow soldering process was performed in accordance with the temperature profile shown in FIG. 1 using an air reflow soldering machine (AIS-20-82-C, manufactured by EIGHTECH TECTRON CO., LTD.).

As shown in FIG. 1, the test piece was 1) heated to 235° C. at a predetermined heating rate, 2) heated to a predetermined set temperature (“a”: 270° C., “b”: 265° C., “c”: 260° C., “d”: 250° C., or “e”: 240° C.) over 20 seconds, and 3) cooled back to 230° C. The highest set temperature was then found at which the test piece was not molten and no blister was observed on its surface. This highest set temperature was defined as a heat resistance temperature.

In general, test pieces subjected to moisture absorption tend to have lower heat resistance temperatures than completely-dried test pieces. In addition, the heat resistance temperature tends to decrease with decreasing polyamide resin-to-flame retardant ratio.

[Flexural Test]

A test piece (length: 64 mm, width: 6 mm, thickness: 0.8 mm) prepared by injection molding was allowed to stand in nitrogen gas atmosphere at 23° C. for 24 hours. Using a flexural tester (AB5, manufactured by NTESCO), a flexural test was performed at 23° C. and at relative humidity of 50% under the following conditions: span=26 m, flexural rate=5 mm/min. In this way the flexural strength, destortion, modulus, and energy required for breaking the test piece (toughness) were measured.

Molding machine: TUPARL TR40S3A (Sodick Plustech Co., Ltd.)

Cylinder temperature: polyamide resin melting point plus 10° C.

Mold temperature: 100° C.

[Flow Length Test (Flow Ability)]

Injection molding was performed under the following condition using a bar-flow mold (width: 10 mm, thickness: 0.5 mm) to measure the flow length (mm) of resin in the mold.

Injection molding machine: TUPARL TR40S3A (Sodick Plustech Co., Ltd.)

Injection pressure: 2,000 kg/cm²

Cylinder set temperature: polyamide resin melting point plus 10° C.

Mold temperature: 120° C.

Polyamide resins (A), flame retardants (B), fatty acid metal salts (C) and reinforcements (D) used in Examples and Comparative Examples will be described below.

### [Polyamide (A)]

### [Polyamide Resin (A-1)]

Composition: Dicarboxylic acid unit (terephthalic acid: 62.5 mol % and adipic acid: 37.5 mol %), Diamine unit (1,6-diaminohexane: 100 mol %)

Intrinsic viscosity [η]: 0.8 dl/g

Melting point: 320° C.

[Polyamide Resin (A-2)]

Composition: Dicarboxylic acid unit (terephthalic acid: 62.5 mol % and adipic acid: 37.5 mol %), Diamine unit (1,6-diaminohexane: 100 mol %)

Intrinsic viscosity [η]: 1.0 dl/g

Melting point: 320° C.

[Polyamide Resin (A-3)]

Composition: Dicarboxylic acid unit (terephthalic acid: 55 mol % and adipic acid: 45 mol %), Diamine unit (1,6-diaminohexane: 100 mol %)

Intrinsic viscosity [η]: 0.8 dl/g

Melting point: 310° C.

[Polyamide Resin (A-4)]

Composition: Dicarboxylic acid unit (terephthalic acid: 55 mol % and adipic acid: 45 mol %), Diamine unit (1,6-diaminohexane: 100 mol %)

Intrinsic viscosity [η]: 1.0 dl/g

Melting point: 310° C.

[Flame Retardant (B)]

EXOLIT OP1230 (phosphorous content=23.8 wt %, manufactured by Clariant (Japan) K.K.)

[Fatty Acid Metal Salt (C)]

Calcium montanate (Licomont CaV102, manufactured by Clariant (Japan) K.K.)

Barium stearate (Ba-St), aluminum stearate (Al-St), calcium stearate (Ca-St), lithium behenate (Li-Beh), calcium behenate (Ca-Beh), lithium montanate (Li-Mon) and zinc montanate (Zn-Mon), manufactured by Nitto Kasei Co., Ltd.

For comparison with fatty acid metal salts, the following fatty acid esters and fatty acid amides were used.

Fatty acid ester of pentaerythritol (Nissan Electol WEP-5, manufactured by Nippon Oil & Fats Co., Ltd.)

Ethylene bis-erucamide (ALFLOW AD-221P, manufactured by Nippon Oil & Fats Co., Ltd.)

[Reinforcement (D)]

Glass fiber (ECS03-615, manufactured by Central Glass Co., Ltd.)

Talc (Hifller #100 Clay 95, manufactured by Matsumura Sangyo Co., Ltd.) Talc content was set to 0.7 wt % based on the total amount of polyamide resin (A), flame retardant (B), fatty acid metal salt (C), reinforcement (D) and talc.

### Examples 1-9 and Comparative Examples 1-9

The above components were mixed in proportions shown in Tables 1 and 2, and the mixtures were fed into a twin-screw vented extruder set to 320° C., and then melt-kneaded to prepare flame-retardant polyamide compositions in the form of pellets. Subsequently, physical properties of the resulting flame-retardant polyamide compositions were evaluated. The results are set forth in Tables 1-3.

TABLE 1

| Material | | Unit | Ex. 1 | Ex. 2 | Comp. Ex. 1 | Comp. Ex. 2 | Comp. Ex. 3 | Comp. Ex. 4 | Comp. Ex. 5 |
|---|---|---|---|---|---|---|---|---|---|
| Polyamide resin (A) | Code | — | (A-1) | (A-1) | (A-1) | (A-1) | (A-2) | (A-3) | (A-4) |
| | Amount | wt % | 52.05 | 50.05 | 60.05 | 48.05 | 50.05 | 50.05 | 50.05 |
| | Intrinsic | dl/g | 0.8 | 0.8 | 0.8 | 0.8 | 1.0 | 0.8 | 1.0 |
| | viscosity | | | | | | | | |
| Metal phosphinate (B) | Amount | wt % | 17 | 19 | 9 | 21 | 19 | 19 | 19 |
| Fatty acid metal | Code(1) | — | CAV102 | CAV102 | CAV102 | CAV102 | CAV102 | CAV102 | CAV102 |
| salt (C) | Amount | wt % | 0.25 | 0.25 | 0.25 | 0.25 | 0.25 | 0.25 | 0.25 |
| | Code (2) | — | — | — | — | — | — | — | — |
| | Amount | wt % | 0 | 0 | 0 | 0 | 0 | 0 | 0 |
| Reinforcement (D) | Amount | wt % | 30 | 30 | 30 | 30 | 30 | 30 | 30 |
| Flammability test | UL-94 | V- | 0 | 0 | 1 | 0 | 0 | 0 | 0 |
| Flexural test | Strength | MPa | 241 | 233 | 253 | 225 | 234 | 226 | 230 |
| | destortion | mm | 3.8 | 3.8 | 4.0 | 3.6 | 3.9 | 3.7 | 4.0 |
| | Flexural | MPa | 11500 | 11600 | 11300 | 11700 | 12000 | 11400 | 11500 |
| | Modulus | | | | | | | | |
| | Tougness | mJ | 53 | 52 | 60 | 47 | 56 | 49 | 55 |
| Reflow heat resistance | | ° C. | 260 | 260 | 270 | 260 | 270 | 240 | 250 |
| temperature | | | | | | | | | |
| Flow length | | mm | 56 | 52 | 62 | 49 | 40 | 49 | 40 |
| Generated gas level | | — | ∘ | ∘ | ∘ | ∘ | ∘ | ∘ | ∘ |
| during molding | | | | | | | | | |

TABLE 2

| Material | | Unit | Ex. 3 | Ex. 4 | Ex. 5 | Ex. 6 | Ex. 7 | Ex. 8 | Ex. 9 |
|---|---|---|---|---|---|---|---|---|---|
| Polyamide resin (A) | Code | — | (A-1) | (A-1) | (A-1) | (A-1) | (A-1) | (A-1) | (A-1) |
| | Amount | wt % | 50.05 | 50.5 | 50.05 | 50.05 | 50.05 | 50.05 | 50.05 |
| | Intrinsic viscosity | dl/g | 0.8 | 0.8 | 0.8 | 0.8 | 0.8 | 0.8 | 0.8 |
| Metal phosphinate (B) | Amount | wt % | 19 | 19 | 19 | 19 | 19 | 19 | 19 |
| Fatty acid metal salt (C) | Code (1) | — | CAV102 | CAV102 | CAV102 | CAV102 | CAV102 | CAV102 | CAV102 |
| | Amount | wt % | 0.5 | 0.75 | 1 | 0.25 | 0.25 | 0.25 | 0.25 |
| | Code (2) | — | — | — | — | Li-Beh | Ca-Beh | Li-Mon | Zn-Mon |
| | Amount | wt % | 0 | 0 | 0 | 0.5 | 0.5 | 0.5 | 0.5 |
| Flow length | | mm | 55 | 58 | 58 | 61 | 58 | 55 | 58 |
| Generated gas level | | — | ∘ | ∘ | Δ | ∘ | ∘ | ∘ | ∘ |
| during molding | | | | | | | | | |

TABLE 3

| Material | | Unit | Comp. Ex. 6 | Comp. Ex. 7 | Comp. Ex. 8 | Comp. Ex. 9 |
|---|---|---|---|---|---|---|
| Polyamide resin (A) | Code | — | (A-1) | (A-1) | (A-1) | (A-1) |
| | Amount | wt % | 50.05 | 50.5 | 50.05 | 50.05 |
| | Intrinsic viscosity | dl/g | 0.8 | 0.8 | 0.8 | 0.8 |
| Metal phosphinate (B) | Amount | wt % | 19 | 19 | 19 | 19 |
| Fatty acid metal salt (C) | Code (1) | — | — | CAV102 | CAV102 | CAV102 |
| | Amount | wt % | 0 | 2 | 0.25 | 0.25 |
| | Code (2) | — | — | — | WEP-5 | AD-221P |
| | Amount | wt % | 0 | 0 | 0.75 | 0.75 |
| Flow length | | mm | 45 | 58 | 52 | 52 |
| Generated gas level | | — | ∘ | x | ∘ | ∘ |
| during molding | | | | | | |

To 99.75 parts by weight of the polyamide resin compositions prepared in Example 2 was added 0.25 parts by weight of fatty acid metal salts (C) shown in Table 4, followed by dry-blending. The blended compositions were injection molded, and the generated gas level during molding was evaluated visually based on the following criteria: Sample with no gas generation was ranked ∘; sample with less gas generation was ranked Δ; and sample with great gas generation and is problematic for usage was ranked x.

Resin compositions with excellent thermal stability are judged to have excellent moldability because they generate less gas and are less likely to smear the mold. Evaluation results are set forth in Table 4.

TABLE 4

| | | Unit | Ex. 10 | Ex. 11 | Ex. 12 | Comp. Ex. 10 | Comp. Ex. 11 |
|---|---|---|---|---|---|---|---|
| Base pellet | Code | — | Ex. 2 | Ex. 2 | Ex. 2 | Ex. 2 | Ex. 2 |
| Later-added | Code | — | CAV102 | Ba-St | Li-Beh | Ca-St | Al-St |
| fatty acid metal salt (C) | Amount | | 0.25 | 0.25 | 0.25 | 0.25 | 0.25 |
| Flow length | | mm | 57 | 58 | 61 | 54 | 59 |
| Generated gas level | | — | ∘ | Δ | ∘ | x | Δ |
| during molding | | | | | | | |

The number of carbon atoms of calcium stearate (Comparative Examples 10 and 11) is smaller than those of lithium behenate, calcium montanate, etc. In addition, the melting point of calcium stearate is the lowest of all the other fatty acid metal salts employed. For these reasons, generated gas level may increase in the case of calcium stearate.

The present application claims the priority of Japanese Patent Application No. 2007-90371 filed on Mar. 30, 2007, the entire contents of which are herein incorporated by reference.

### INDUSTRIAL APPLICABILITY

The flame-retardant polyamide composition of the present invention is, without containing any halogen flame retardant, excellent in mechanical properties (e.g., toughness), heat resistance, flame retardancy and flow ability during a reflow soldering process, as well as has good thermal stability during molding.

In particular, the flame-retardant polyamide composition of the present invention can be suitably used in electric applications where thin molded articles like fine-pitch connectors are surface-mounted using high-melting point solder such as lead-free solder, or in the field of precise molding.

1. A flame-retardant polyamide composition comprising:
20-80 wt % polyamide resin (A);
10-20 wt % flame retardant (B) containing no halogens in the molecule thereof;
0.05-1 wt % fatty acid metal salt (C); and
0-50 wt % reinforcement (D),
wherein the flame retardant (B) is a metal phosphinate, and the fatty acid metal salt (C) is a lithium salt, calcium salt, barium salt, zinc salt or aluminum salt of montanic acid, behenic acid or stearic acid (except for calcium stearate and aluminum stearate), or a mixture thereof.

2. The flame-retardant polyamide composition according to claim 1, wherein the polyamide resin (A) has multifunctional carboxylic acid unit (a-1) and multifunctional amine unit (a-2) having 4-25 carbon atoms, and 60-100 mol % of the multifunctional carboxylic acid unit (a-1) is a terephthalic acid unit, 0-40 mol % of the multifunctional carboxylic acid unit (a-1) is a multifunctional aromatic carboxylic acid unit other than terephthalic acid, and 0-40 mol % of the multifunctional carboxylic acid unit (a-1) is a multifunctional aliphatic carboxylic acid unit having 4-20 carbon atoms.

3. The flame-retardant polyamide composition according to claim 1, wherein the polyamide resin (A) has a melting point of 280-340° C. and an intrinsic viscosity [η], as measured in concentrated sulfuric acid at 25° C., of 0.5-0.95 dl/g.

4. The flame-retardant polyamide composition according to claim 1, wherein the flame retardant (B) is aluminum diethylphosphinate.

5. The flame-retardant polyamide composition according to claim 1, wherein the fatty acid metal salt (C) is selected from the group consisting of calcium montanate, zinc montanate, barium stearate, calcium behenate, lithium behenate and mixtures thereof.

6. The flame-retardant polyamide composition according to claim 5, wherein the fatty acid metal salt (C) is at least one compound selected from the group consisting of calcium montanate and lithium behenate.

7. A molded article prepared by molding a flame-retardant polyamide composition according to claim 1.

8. An electric part prepared by molding a flame-retardant polyamide composition according to claim 1.

9. A method of producing a flame-retardant polyamide composition according to claim 1 comprising:
mixing polyamide resin (A) polymer with metal phosphinate (B) and fatty acid metal salt (C) to prepare a mixture; and
molding the mixture by melt extrusion molding.

10. A method of producing a flame-retardant polyamide composition according to claim 1 comprising:
preparing a resin composition containing polyamide resin (A), flame retardant (B), and optionally reinforcement (D);
adding fatty acid metal salt (C) to the resin composition; and
molding the resin composition containing the fatty acid metal salt (C) by extrusion molding.
